(19) United States
(12) Patent Application Publication
(10) Pub. No.: US 2025/0309459 A1
(43) Pub. Date: Oct. 2, 2025

(54) BATTERY ARRAY VENT GAS MANAGEMENT

(71) Applicant: FORD GLOBAL TECHNOLOGIES, LLC, Dearborn, MI (US)

(72) Inventor: Xiaogang ZHANG, Novi, MI (US)

(21) Appl. No.: 18/617,803

(22) Filed: Mar. 27, 2024

(51) Int. Cl. H01M 50/367; H01M 10/658; H01M 50/204; H01M 50/249; H01M 50/271; H01M 50/342

(52) U.S. Cl. CPC H01M 50/367; H01M 10/658; H01M 50/204; H01M 50/249; H01M 50/271; H01M 50/3425; H01M 2200/20; H01M 2220/20

(57) ABSTRACT

Vent management systems are provided for traction battery packs. A battery array of the traction battery pack may be configured to establish a dedicated vent flow gas path for expelling battery vent byproducts from the traction battery pack during a battery thermal event. The vent flow gas path may be established by a cover and a pair of insulation bars of the battery array. In some implementations, the battery array may further include an insulation shield for insulating certain battery cell surfaces from vent gas flow during the battery thermal event.

### TECHNICAL FIELD

This disclosure relates generally to electrified vehicle traction battery packs, and more particularly to vent management systems capable of expelling battery vent byproducts from battery arrays.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, a battery cell, a cover positioned adjacent to the battery cell, a first insulation bar and a second insulation bar arranged between the battery cell and the cover, and a vent gas flow path extending between the first insulation bar and the second insulation bar.

In a further non-limiting embodiment of the foregoing battery array, the vent gas flow path is fluidly isolated from a section of an interior volume of the battery array.

In a further non-limiting embodiment of either of the foregoing battery arrays, the vent gas flow path extends horizontally between the first insulation bar and the second insulation bar and extends vertically between a top surface of the battery cell and an inner surface of the cover.

In a further non-limiting embodiment of any of the foregoing battery arrays, the battery array includes a second battery cell, and a thermal barrier is positioned between the battery cell and the second battery cell.

In a further non-limiting embodiment of any of the foregoing battery arrays, an insulation shield is positioned between a top surface of the battery cell and the first insulation bar and the second insulation bar.

In a further non-limiting embodiment of any of the foregoing battery arrays, the insulation shield includes a membrane and a plurality of perforated sections formed in the membrane.

In a further non-limiting embodiment of any of the foregoing battery arrays, the cover includes a first flared section sized to receive the first insulation bar and a second flared section sized to receive the second insulation bar.

In a further non-limiting embodiment of any of the foregoing battery arrays, the first flared section and the second flared section are each semi-circular shaped.

In a further non-limiting embodiment of any of the foregoing battery arrays, the battery cell includes a first terminal, a second terminal, and a vent port arranged between the first terminal and the second terminal.

In a further non-limiting embodiment of any of the foregoing battery arrays, the first insulation bar is located between the first terminal and the vent port, and the second insulation bar is located between the second terminal and the vent port.

In a further non-limiting embodiment of any of the foregoing battery arrays, the vent port is arranged to vent directly into the vent gas flow path.

In a further non-limiting embodiment of any of the foregoing battery arrays, the first insulation bar and the second insulation bar are each configured as a circular rod that is made of a high temperature capable material having a relatively low thermal conductivity.

A battery array for a traction battery pack according to another exemplary aspect of the present disclosure includes, among other things, a grouping of battery cells, a cover positioned adjacent to the grouping of battery cells and including a first flared section and a second flared section, a first insulation bar positioned within the first flared section, and a second insulation bar positioned within the second flared section.

In a further non-limiting embodiment of the foregoing battery array, the battery array includes a vent gas flow path extending between the first insulation bar and the second insulation bar and between an inner surface of the cover and top surfaces of the grouping of battery cells.

In a further non-limiting embodiment of either of the foregoing battery arrays, the vent gas flow path is fluidly isolated from a section of an interior volume of the battery array.

In a further non-limiting embodiment of any of the foregoing battery arrays, an insulation shield is positioned between top surfaces of the grouping of battery cells and the first insulation bar and the second insulation bar.

In a further non-limiting embodiment of any of the foregoing battery arrays, each battery cell of the grouping of battery cells includes a first terminal, a second terminal, and a vent port located axially between the first terminal and the second terminal.

In a further non-limiting embodiment of any of the foregoing battery arrays, the first insulation bar is located between the first terminal and the vent port, and the second insulation bar is located between the second terminal and the vent port.

In a further non-limiting embodiment of any of the foregoing battery arrays, the vent port is arranged to vent directly into a vent gas flow path that extends between the first insulation bar and the second insulation bar and between an inner surface of the cover and top surfaces of the grouping of battery cells.

In a further non-limiting embodiment of any of the foregoing battery arrays, the first flared section and the second flared section are each semi-circular shaped.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates an exemplary battery array of a traction battery pack.

FIG. 3 is a cross-sectional view through section 3-3 of FIG. 2.

FIG. 4 illustrates another exemplary battery array.

FIG. 5 is a cross-sectional view through section 5-5 of FIG. 4.

FIG. 6 illustrates an insulation shield of the battery array of FIGS. 4-5.

### DETAILED DESCRIPTION

This disclosure details vent management systems for traction battery packs. A battery array of the traction battery pack may be configured to establish a dedicated vent flow gas path for expelling battery vent byproducts from the traction battery pack during a battery thermal event. The vent flow gas path may be established by a cover and a pair of insulation bars of the battery array. In some implementations, the battery array may further include an insulation shield for insulating certain battery cell surfaces from vent gas flow during the battery thermal event. These and other features are discussed in greater detail in the following paragraphs of this detailed description.

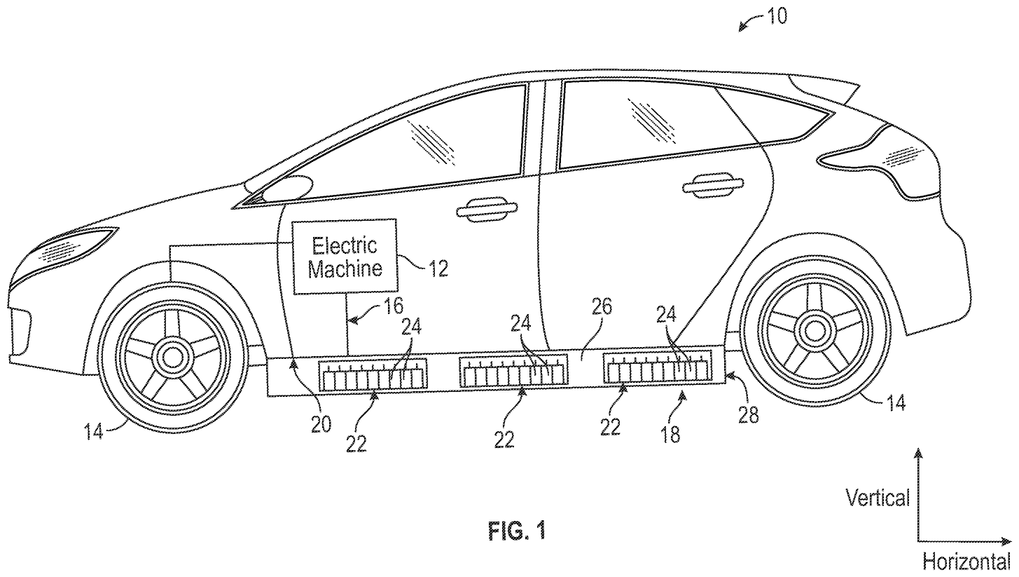

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

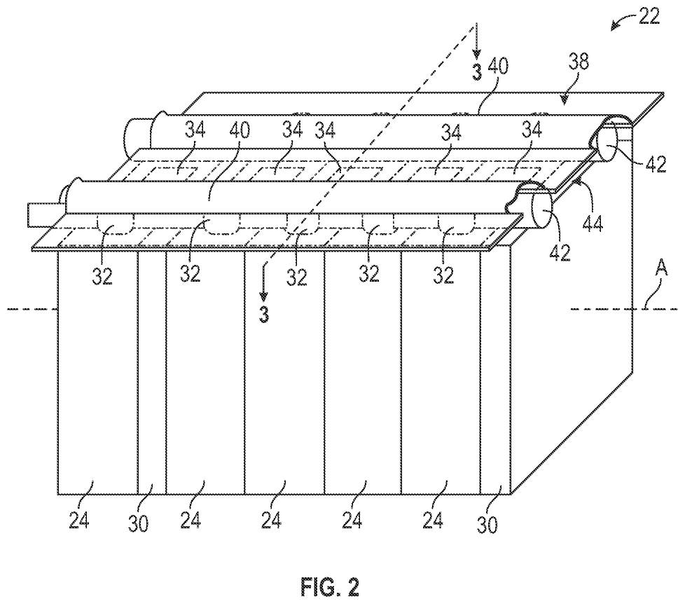

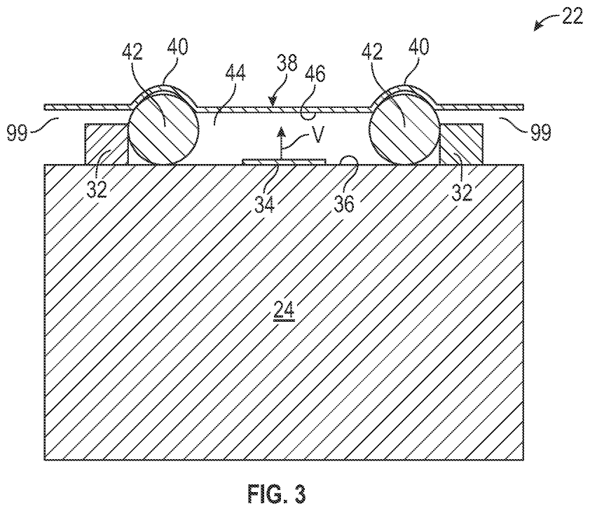

FIGS. 2 and 3 illustrate select portions of a battery array 22 for a traction battery pack. For example, the traction battery pack 18 of the electrified vehicle 10 of FIG. 1 could include one or more battery arrays having a design similar to that of the battery array 22 of FIGS. 2-3.

The battery array 22 may include a plurality of battery cells 24 that are arranged along a stack axis A to construct a grouping of battery cells 24, sometimes referred to as a “cell stack.” The battery cells 24 may be arranged together with thermal barriers 30 along the stack axis A. In an embodiment, groups of four individual battery cells 24 are separated by thermal barriers 30 along the stack axis A. However, depending on various design specific requirements, the battery array 22 could include any number of and any arrangement of battery cells 24 and thermal barriers 30.

The thermal barriers 30 may be configured to limit conductive heat transfer across the cell stack. The thermal barriers 30 may be made of aerogel, mica, or any other suitable material or combinations of materials.

Each battery cell 24 of the battery array 22 may include a pair of terminals 32 and a vent port 34. The terminals 32 may project upwardly from a top surface 36 of each battery cell 24, and the vent port 34 may be provided within the top surface 36 at a location that is axially between the pair of terminals 32. However, other arrangements are contemplated within the scope of this disclosure. In an embodiment, each vent port 34 is a pressure activated vent port.

A cover 38 of an array housing may be positioned relative to the grouping of battery cells 24 and thermal barriers 30. Although not specifically shown, the cover 38 may interface with additional panels of the array housing for enclosing the cell stack of battery cells 24 and thermal barriers 30.

In an embodiment, the cover 38 is a top cover that is positioned over top of the top surfaces 36 of the battery cells 24. Thus, the terminals 32 and the vent port 34 may each face in a direction toward the cover 38. However, other arrangements are contemplated within the scope of this discourse.

The cover 38 may include a pair of flared sections 40. When the cover 38 is installed relative to the cell stack, the flared sections 40 protrude in a direction away from the battery cells 24. Each flared section 40 may establish an elongated semi-circular shaped channel that is sized and shaped to receive a portion (e.g., about ⅓) of an outer circumference of an insulation bar 42. The insulations bars 42 may be configured as circular rods that are made of a high temperature capable material having a relatively low thermal conductivity.

The insulation bars 42 may be arranged to extend between the top surfaces 36 of the battery cells 24 and the cover 38. In an embodiment, one of the insulation bars 42 is positioned axially between the vent ports 34 and the terminals 32 located on one side of the battery cells 24, and the other insulation bar 42 may be positioned axially between the vent ports 34 and the terminals 32 located on an opposite side of the battery cells 24 (best shown in FIG. 3).

The cover 38, the insulations bars 42, and the battery cells 24 may cooperate to establish a dedicated vent gas flow path 44 for collecting and expelling battery vent byproducts V from the battery array 22 and then the traction battery pack 18 as part of a vent management strategy. The vent gas flow path 44 may extend vertically between the top surfaces 36 of the battery cells 24 and an inner surface 46 of the cover 38 and horizontally between the spaced apart insulation bars 42.

One or more of the battery cells 24 of the battery array 22 can periodically release the battery vent byproducts V through the vent port 34, such as during a thermal event caused by an overcharge condition, an overdischarging condition, a short circuit condition, etc. Pressure increases within one of the battery cells 24 can cause the vent port 34 to rupture, thereby creating a path for the battery vent byproducts V to be released from inside the battery cell 24. The battery vent byproducts V can include gases and effluent particles.

Each vent port 34 may be arranged to vent directly into the vent gas flow path 44 of the battery array 22 during a thermal event. Once an individual battery cell 24 releases battery vent byproducts V, the battery vent byproducts V may flow through the vent gas flow path 44 prior to being expelled from the battery array 22 and then from the traction battery pack 18, such as to atmosphere, for example. The venting battery cell 24 therefore provides little to no thermal influence on neighboring battery cells 24 of the battery array 22 during the thermal event, thereby limiting convective heat transfer across the cell stack.

Although not shown, the vent gas flow path 44 may be fluidly connected to one or more of fluid manifolds, hoses, tubing, etc. for expelling the released battery vent byproducts V from the battery array 22 and then from the traction battery pack 18.

The vent gas flow path 44 may be fluidly isolated from other sections 99 of the interior volume of the battery array 22. Released battery vent byproducts V can therefore travel along a vent flow path that is separate from a coolant flow path where a cooling fluid can be circuited through the interior volume of the battery array 22 in order to convectively cool the battery cells 24, for example. The cooling fluid therefore cannot intermix with and is not heated by the battery vent byproducts V during thermal events, thereby reducing or even eliminating convective heat transfer that could be caused by the battery vent byproducts V during the thermal event.

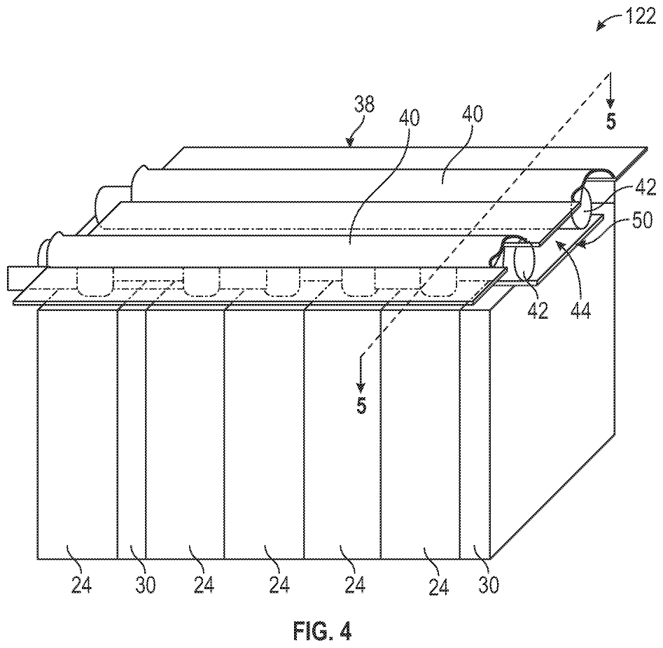

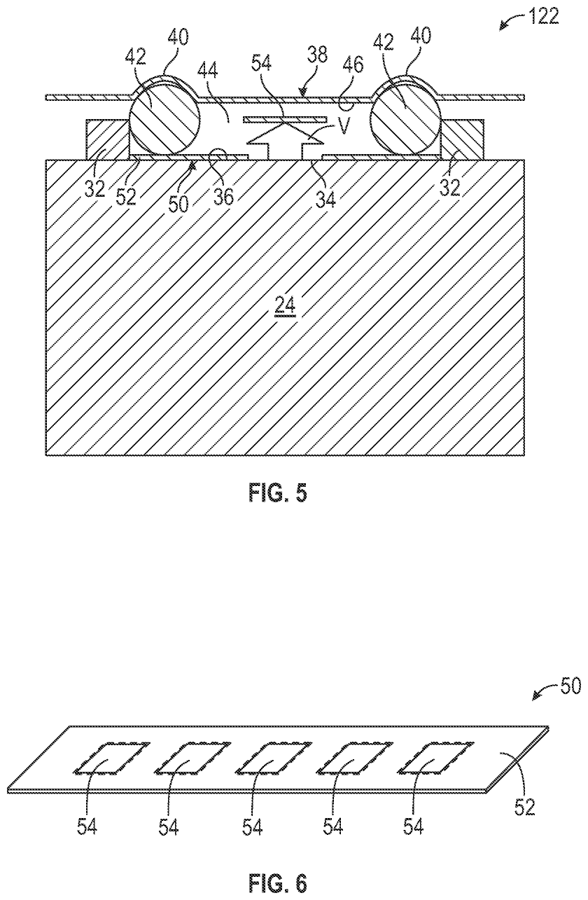

FIGS. 4 and 5 illustrate another exemplary design of a battery array 122 that can be utilized within the traction battery pack 18 of FIG. 1. The battery array 122 is similar to the battery array 22 discussed above but includes minor modifications for insulating the top surfaces 36 of the battery cells 24 from exposure to battery vent byproducts V during battery thermal events.

In this embodiment, an insulation shield 50 may be arranged between the insulation bars 42 and the top surfaces 36 of the battery cells 24. The insulation bars 42 may compress the insulation shield 50 against the top surfaces 36 for sealing the vent gas flow path 44, thereby preventing battery vent byproducts V from flowing directly across the terminals 32 of the battery cells 24 during a thermal event.

In an embodiment, the insulation shield 50 is a mica sheet. However, the insulation shield 50 could be constructed from other materials within the scope of this disclosure.

The insulation shield 50 may include a membrane 52 that includes a plurality of perforated sections 54 (see FIGS. 5 and 6). The perforated sections 54 may be rectangular shaped or could embody any other suitable shape. The insulation shield 50 may be arranged within the vent gas flow path 44 such that the perforated sections 54 are positioned directly over top of the vent ports 34. The perforated section(s) 54 that is located above a venting battery cell(s) 24 may locally break away from the membrane 52 or otherwise rupture to allow the battery vent byproducts V to pass through the membrane 52 and into the vent gas flow path 44 during a thermal event. The portions of the membrane 52 that do not rupture remain in place to protect the top surfaces 36 of the battery cells 24 from exposure to the battery vent byproducts V as the battery vent byproducts V flow through the vent gas flow path 44.

The exemplary battery arrays of this disclosure include dedicated vent gas flow paths that establish a vent management system for expelling battery vent byproducts from the battery array during a thermal event. The dedicated vent gas flow paths can effectively manage vent gases while limiting convective heat transfer to nearby battery cells and/or battery arrays.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
a battery cell;
a cover positioned adjacent to the battery cell;
a first insulation bar and a second insulation bar arranged between the battery cell and the cover; and
a vent gas flow path extending between the first insulation bar and the second insulation bar.

2. The battery array as recited in claim 1, wherein the vent gas flow path is fluidly isolated from a section of an interior volume of the battery array.

3. The battery array as recited in claim 1, wherein the vent gas flow path extends horizontally between the first insulation bar and the second insulation bar and extends vertically between a top surface of the battery cell and an inner surface of the cover.

4. The battery array as recited in claim 1, comprising a second battery cell, and a thermal barrier positioned between the battery cell and the second battery cell.

5. The battery array as recited in claim 1, comprising an insulation shield positioned between a top surface of the battery cell and the first insulation bar and the second insulation bar.

6. The battery array as recited in claim 5, wherein the insulation shield includes a membrane and a plurality of perforated sections formed in the membrane.

7. The battery array as recited in claim 1, wherein the cover includes a first flared section sized to receive the first insulation bar and a second flared section sized to receive the second insulation bar.

8. The battery array as recited in claim 7, wherein the first flared section and the second flared section are each semi-circular shaped.

9. The battery array as recited in claim 1, wherein the battery cell includes a first terminal, a second terminal, and a vent port arranged between the first terminal and the second terminal.

10. The battery array as recited in claim 9, wherein the first insulation bar is located between the first terminal and the vent port, and the second insulation bar is located between the second terminal and the vent port.

11. The battery array as recited in claim 10, wherein the vent port is arranged to vent directly into the vent gas flow path.

12. The battery array as recited in claim 1, wherein the first insulation bar and the second insulation bar are each configured as a circular rod that is made of a high temperature capable material having a relatively low thermal conductivity.

13. A battery array for a traction battery pack, comprising:
a grouping of battery cells;
a cover positioned adjacent to the grouping of battery cells and including a first flared section and a second flared section;
a first insulation bar positioned within the first flared section; and
a second insulation bar positioned within the second flared section.

14. The battery array as recited in claim 13, comprising a vent gas flow path extending between the first insulation bar and the second insulation bar and between an inner surface of the cover and top surfaces of the grouping of battery cells.

15. The battery array as recited in claim 14, wherein the vent gas flow path is fluidly isolated from a section of an interior volume of the battery array.

16. The battery array as recited in claim 13, comprising an insulation shield positioned between top surfaces of the grouping of battery cells and the first insulation bar and the second insulation bar.

17. The battery array as recited in claim 13, wherein each battery cell of the grouping of battery cells includes a first terminal, a second terminal, and a vent port located axially between the first terminal and the second terminal.

18. The battery array as recited in claim 17, wherein the first insulation bar is located between the first terminal and the vent port, and the second insulation bar is located between the second terminal and the vent port.

19. The battery array as recited in claim 18, wherein the vent port is arranged to vent directly into a vent gas flow path that extends between the first insulation bar and the second insulation bar and between an inner surface of the cover and top surfaces of the grouping of battery cells.

20. The battery array as recited in claim 13, wherein the first flared section and the second flared section are each semi-circular shaped.
